(19) United States
(12) Patent Application Publication
(10) Pub. No.: US 2019/0315147 A1
(43) Pub. Date: Oct. 17, 2019

(54) Greeting Card with Removable Mobile Object

(71) Applicant: American Greetings Corporation, Cleveland, OH (US)

(72) Inventors: Sean Higgins, Lakewood, OH (US); Sarah Eklund, Cleveland, OH (US); Katalina Speck, Rocky River, OH (US); Mary Bank, Medina, OH (US); Anthony Begin, Cleveland, OH (US); Allison Marsh, Olmsted Township, OH (US)

(21) Appl. No.: 15/953,556

(22) Filed: Apr. 16, 2018

(51) Int. Cl. B42D 15/04; B42D 15/02; A63H 17/26

(52) U.S. Cl. CPC B42D 15/045; A63H 17/26; B42D 15/022

(57) ABSTRACT

A greeting card having a mobile object releasably attached thereto. The mobile object may be shaped like a character or object with one or more wheels at a bottom surface thereof. The mobile object may be removed from the greeting card and set upright onto a surface. Activating a motor module within the mobile object causes the one or more wheels to rotate, setting the mobile object rolling along said surface.

### RELATED APPLICATIONS

There are no applications related to this application.

### FIELD OF THE INVENTION

The present invention is in the field of social expression product and more specifically is directed to a greeting card having a removable mobile character.

### SUMMARY OF THE INVENTION

In one embodiment, a greeting card includes a greeting card body and a mobile object which is removably attached to the greeting card body. The mobile object includes a body having one or more compartments therein, two wheels, a motor module, and switch mechanism, which controls activation of the motor module. Placing the mobile object in an upright position with the two wheels on a horizontal surface and activating the switch mechanism causes the mobile object to roll along said surface.

In another embodiment, a greeting card includes a greeting card body and a mobile object releasably attached to the greeting card body. The mobile object includes a body, at least one wheel, a motor module, and a switch. Placing the at least one wheel in contact with a horizontal surface and activating the motor module via the switch, causes the at least one wheel to rotate and move along the horizontal surface.

In yet another embodiment, a greeting card includes a greeting card body, and a mobile object releasably attached to the greeting card body. The mobile object includes two wheels located at a lower surface thereof, a motor module contained within the mobile object which is operative to cause the two wheels to rotate, and a switch which controls activation of the motor module.

### DESCRIPTION OF THE DRAWINGS

FIG. 1 is a perspective view of the mobile object of the greeting card of the present invention.

FIG. 2 is a front view of the mobile object of FIG. 1.

FIG. 3 is a perspective view of the mobile object of FIG. 1, with extended kickstand.

FIG. 4 is a bottom up view of the mobile object of FIG. 1.

FIG. 5 is a perspective view of the greeting card of the present invention, in a slightly open position

### DETAILED DESCRIPTION OF PREFERRED AND ALTERNATE EMBODIMENTS

The greeting card 100 of the present disclosure and related inventions includes a greeting card body 10 with attached three-dimensional mobile object 12. The mobile object 12 contains a motor 34 therein and one or more wheels 16 which allow the mobile object 12 to travel along a surface when activated.

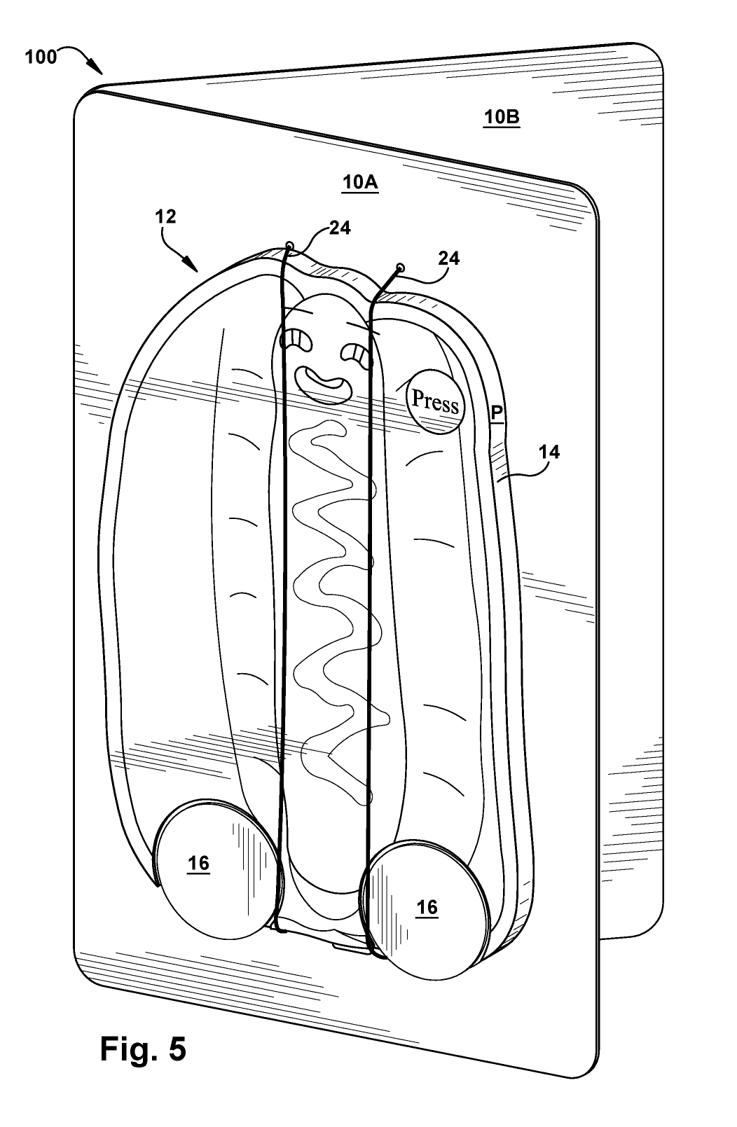

The greeting card body 10 may, in one embodiment, be a traditional two panel greeting card, configured into a standard book, square or portrait fold, with a first panel 10A and a second panel 10B attached along a fold line, as shown in FIG. 5. The fold line may be in a vertical or horizontal configuration. One or more of the greeting card panels 10A, 10B may contain text sentiment, photos, pictures, drawings, artwork or any other printable material. One or more of the greeting card panels 10A, 10B may additionally contain three-dimensional adornments, such as, for example, gems, googly eyes, stickers, feathers, glitter, etc. In other embodiments, the greeting card body 10 may have a fewer or greater number of panels and may take on a different configuration such as, for example, a tent or landscape fold, tri-fold, z-fold, s-fold, accordion fold, gatefold, or any other folded arrangement. In still other embodiments, the greeting card body 10 may be a single panel.

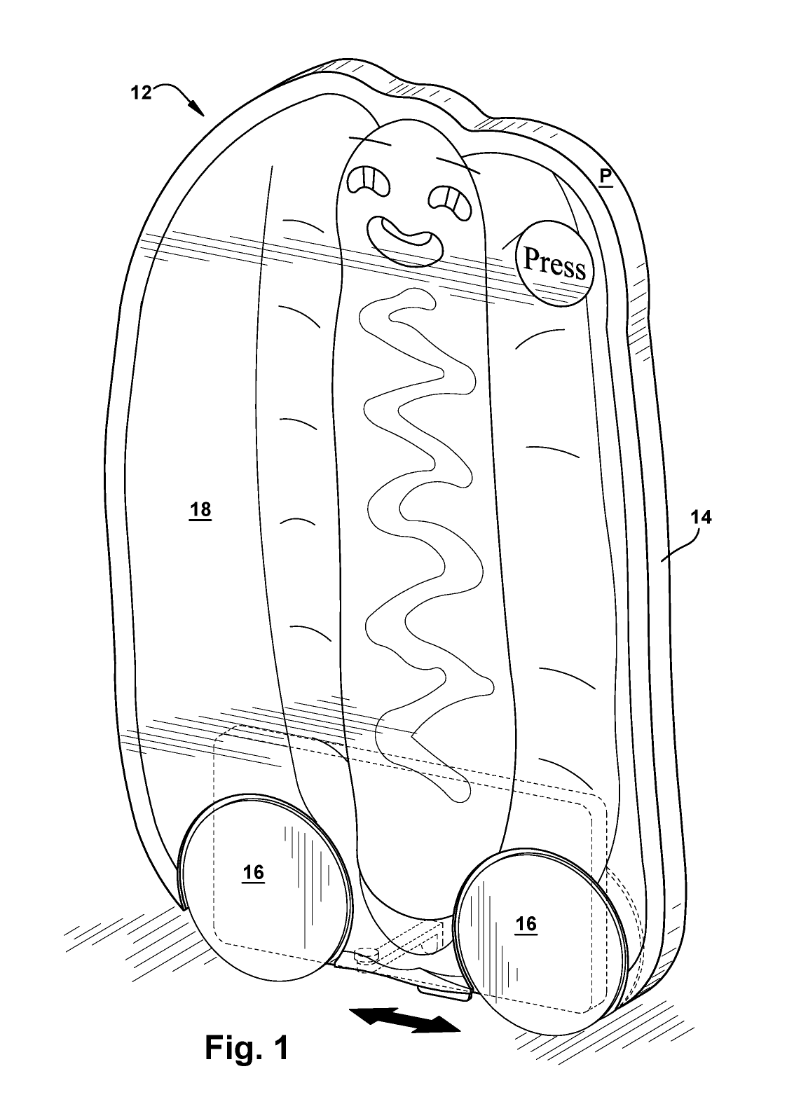

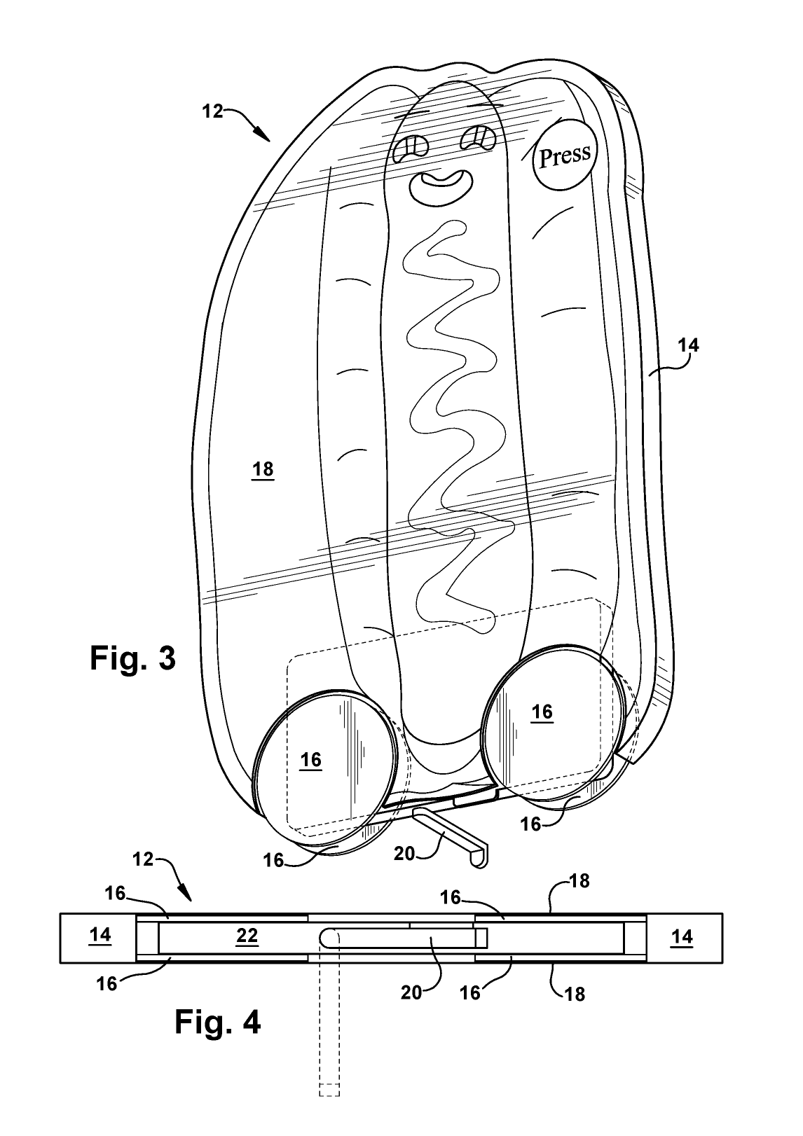

The three-dimensional mobile object or character (hereinafter referred to as “mobile object” or “mobile character”) 12 is removably attached to the greeting card body 10, as shown in FIG. 5. The character contains a foam body (hereinafter referred to as “foam body” or “character body”) 14 having one or more openings or compartments 25 therein. The foam body 14, in one embodiment, contains a first surface and a second surface opposite the first surface with a perimeter surface P which extends between the first and second surfaces. One or more surfaces of the foam body 14 may be covered by a sheet material 18. For example, as shown in the figures, the first and second surfaces of the foam body 14 are covered by a planar sheet material 18. The foam body 14 and sheet material 18 may be shaped as a character or object, such as, for example, a hot dog, as shown in the figures. Other example character and object shapes are a slice of pizza, an animal, an emoji, a person, a cartoon character, a car or any other character or object type. In one embodiment, the sheet material 18 covering one or more panels of the foam body 14 is shaped in the same fashion as the foam body 18, to display a neat and clean appearance. The sheet material 18 may be, in one embodiment, a paperboard panel. The sheet material 18 may contain text sentiment, photos, pictures, drawings, artwork, or any other printable material thereon. The sheet material 18 may additionally contain adornments, such as gems, googly eyes, glitter, stickers, feathers, etc. The sheet material 18 can have printing and/or adornments thereon which resemble or depict the character into which the foam body 14 and sheet material 18 have been shaped. The mobile character 12 may contain, in one embodiment, one or more wheels 16 which enable the mobile character 12 to move or roll along a horizontal surface. In another embodiment, the mobile character 12 may contain two wheels 16, as shown in FIGS. 1, 2, 3 and 5. The mobile character 12 also contains a kickstand 20 which is a lever which can be moved between a first position, wherein it lies in a position parallel to the bottom surface of the motor casing 22, as shown in FIG. 4, and a second position wherein it is moved to a position which is perpendicular or non-parallel to the motor casing 22, as shown in FIG. 3. The kickstand 20 allows the mobile character 12 to stand in an upright position while not in motion, such as for example, on display on a shelf, desk or other surface. At retail, before purchase, the character 12 may be removably attached to the greeting card body 10, and beneath a protective transparent plastic sheath or cover. The character 12 may be removably attached to the greeting card body 10, in one embodiment, one or more filament strings 24 or any other removable attachment mechanism, as shown in FIG. 5.

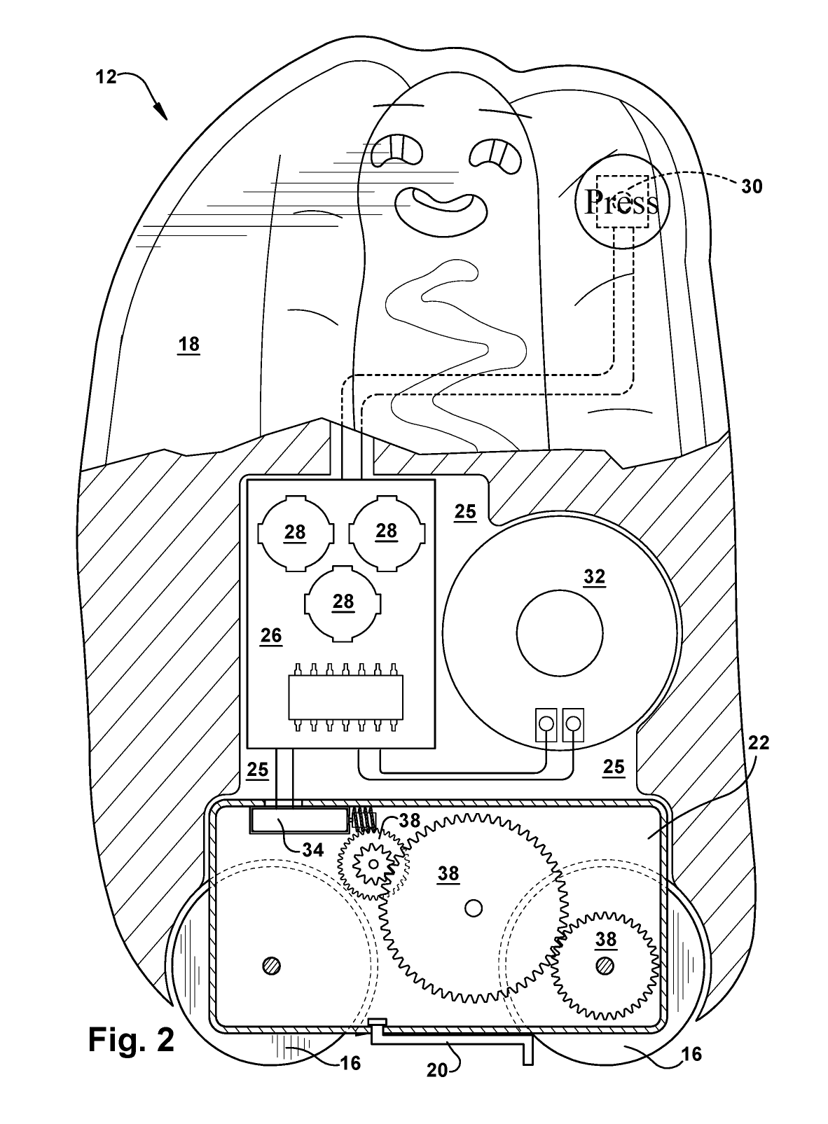

Electronic components of the greeting card 100 of the present disclosure and related inventions may be contained within one or more openings or compartments 25 in the foam body 14. the electronic components may include but are not limited to: a printed circuit board 26 with integrated circuit chip, a memory chip or device having at least one audio file contained thereon, a power source, such as one or more small cell batteries 28, a switch 30, a speaker 32, a motor 34, and related wiring and circuitry. Any other electronic component which is necessary for or which facilitates audio playback through the speaker 32 or motor movement of the mobile character 12 may also be included. The motor 34 may be a miniature motor in the type shown in the FIG. 2, having a gear rotating mechanism 36 which turns one or more circular gears 38 which effect rotational movement of the one or more wheels 16 connected thereto. In one embodiment, the motor 34, gears 38 and a substantial portion of the wheel or wheels 16 are contained within the motor casing 22. A portion of the wheel or wheels 16 are positioned in a lower portion of the motor casing 22 along the bottom edge of the character body 12. A portion of the wheel or wheels 16 extend below the character body 12 such that the wheel or wheels 16 may make freely rotate and make contact with a table or other surface along which it may move or roll, as shown in FIG. 1. In one embodiment, a push button switch 30 is contained within the one or more openings or compartments 25 in the foam body 14 of the mobile character 12. The push button switch 30 may be activated through a front surface of the mobile character 12. The sheet material 16 covering the front surface may contain printing thereon or may contain a sticker which indicates the area in which the user must press in order to activate the motor and/or sound module. Pressing the push button 30 causes activation of the motor 34 which sets the gears 38 and wheels 16 in motion and, in one embodiment, may also activate a sound module which causes playback of audio through a speaker 32. Placing the mobile character 12 in an upright vertical position and placing the bottom surface or wheels 16 of the character 12 onto a table or other surface, as shown in FIG. 1, allows the character 12 to travel or roll along said surface. The character 12 may continue moving or rolling for a predetermined amount of time, such as, for example ten to twenty seconds and/or the motor 34 may deactivate, ceasing movement of the character 12, upon a subsequent press of the push button switch 30. The push button 30 operates similar to a toggle or on/off switch wherein a first press of the button 30 activates or turns the motor 34 and/or audio “on” and a subsequent press of the button 30 deactivates or turns the motor 34 and/or audio “off”, etc.

In one embodiment of the present disclosure and related inventions, the character 12 may contain a gift card which is removably attached thereto. In one embodiment, the gift card may be attached to the character via low adhesive glue, hook and loop patches, or any other attachment mechanism. In another embodiment, the character 12 may have two or more slits or small openings into which a portion of a gift card, such as two or more corners can be inserted to attach the gift card to the character 12. In another embodiment, the character 12 may have a slot or pocket thereon which is dimensioned to accommodate the insertion and removal of a standard-sized gift card. The slot or pocket may have an open edge or may have an open edge with a flap or pocket covering the open edge. The flap or pocket may be opened or lifted to reveal the open edge. The various ways to attach a gift card to the character 12 described herein and intended as examples and do not limit the invention in any way. The gift card may be attached to the character, directly or indirectly, using any type of attachment means. In another embodiment, the character 12 itself can be the gift card.

The greeting card with mobile character 100 of the present disclosure and related inventions is an exciting and surprising way to give a greeting card to a recipient having a small token gift included therewith. The mobile character 12 can be retained as a keepsake after the greeting card body 10 has been thrown away.

While the greeting card with mobile character has been described herein and shown in the figures as being of a particular shape and fold type, other shapes and fold types can be used and are considered to be within the scope of the present invention. The switch has been described and shown as being a push button switch, however, other switch mechanisms, including, but not limited to: a slide switch, a magnetic switch, a light sensitive switch, a touch sensitive switch, a contact switch, a lever switch can be used. A single switch may control activation of both the sound module and motor or two switches may each control activation of the sound module or motor. The motor has been described and shown as being the type having a gear rotating mechanism and one or more gears which effect movement of the wheels, however other motor types can be used. The materials described herein are intended to describe an example embodiment and are not intended to limit the material selection for any component of the present invention in any way.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A greeting card comprising:
a two-page greeting card body;
a mobile object completely removably attached to one page of the two-page greeting card body, the mobile object comprising a body having one or more compartments therein, two wheels, a motor, and switch mechanism;
wherein the switch mechanism controls activation of the motor; and
wherein placing the mobile object in an upright position with the two wheels on a horizontal surface and activating the switch mechanism causes the mobile object to roll along said surface.

2. The greeting card of claim 1 wherein the greeting card is operative to store and playback at least one audio file through a speaker.

3. (canceled)

4. The greeting card of claim 1, wherein the switch mechanism is a push button switch.

5. The greeting card of claim 4, wherein the push button switch is accessed through a front surface of the mobile object.

6. The greeting card of claim 1 further comprising a kickstand which can be positioned to support the mobile object in an upright position for display.

7. The greeting card of claim 1, wherein the body of the mobile object contains a sheet material attached to at least one surface thereof.

8. A greeting card comprising:
a greeting card having two panels attached along a fold line;
a mobile object comprising a body, at least one wheel, a motor, and a switch, the mobile object being attached to but completely removable from the greeting card;
wherein placing the at least one wheel in contact with a horizontal surface and activating the motor via the switch, causes the at least one wheel to rotate and move along the horizontal surface.

9. The greeting card of claim 8, wherein the greeting card is operative to store and playback at least one audio file.

10. (canceled)

11. The greeting card of claim 8, wherein the mobile object contains two wheels.

12. The greeting card of claim 8, wherein the switch is a press button switch.

13. The greeting card of claim 8, wherein once activated, the mobile object will move for a predetermined amount of time or until the press button is pushed.

14. The greeting card of claim 8 further comprising a kickstand which can be positioned to retain the mobile object in an upright position while not activated.

15. A greeting card comprising:
a greeting card body;
a mobile object releasably attached to the greeting card body, the mobile object comprising two wheels located at a lower surface thereof;
a motor contained within the mobile object, the motor module operative to cause the two wheels to rotate;
a switch which controls activation of the motor module.

16. The greeting card of claim 15 wherein the greeting card is operative to store and playback at least one audio file.

17. (canceled)

18. The greeting card of claim 15 further comprising a kickstand which can be positioned to retain the mobile object in an upright or standing position.

19. The greeting card of claim 15, wherein the mobile object is formed into the shape of a character.

20. The greeting card of claim 15, wherein the mobile object will move for a predetermined amount of time or until the press button is pushed.
